(19) United States
(12) Patent Application Publication
(10) Pub. No.: US 2026/0330571 A1
(43) Pub. Date: Oct. 22, 2026

(54) SYSTEMS AND METHODS FOR ENHANCED LAND USE PERMITTING

(71) Applicant: SAUDI ARABIAN OIL COMPANY, Dhahran (SA)

(72) Inventors: Hussain Adel ALTHAWADI, Dhahran (SA); Mazen ALALYANI, Dhahran (SA); Abdulkareem ALMAKRAMI, Abqaiq (SA); Yazan ALAHMADI, Dhahran (SA)

(73) Assignee: SAUDI ARABIAN OIL COMPANY, Dhahran (SA)

(21) Appl. No.: 19/184,418

(22) Filed: Apr. 21, 2025

(51) Int. Cl. G06Q 50/163

(52) U.S. Cl. CPC G06Q 50/163

(57) ABSTRACT

Computer-implemented methods for enhanced land use permitting and systems for performing the same. Methods provided herein may include obtaining a request defining one or more target land use permits, associating the one or more target land use permits with spatial data, the spatial data comprising layer information, geometry information, and element information, constructing a permit structure based on at least the geometry information of the spatial data, the permit structure defining permit type, target location, and period of use for each of the one or more target land use permits, and outputting, in response to the request, a report to a user, the report generated based on the permit structure and having an assignment.

### BACKGROUND OF THE DISCLOSURE

Land use permitting processes aid regulation of land within a given jurisdiction. These processes ensure that land use aligns with local zoning laws, environmental regulations, and community planning objectives. However, the land use permitting process can be fraught with challenges that impact the efficiency and fairness of development projects. One significant challenge is the complexity of navigating multiple layers of regulations and requirements, which can vary significantly between jurisdictions. This complexity can lead to long permit processing delays and increased costs for developers.

Despite efforts to streamline land use permitting processes, current methods may still fall short in achieving optimal efficiency and fairness. Accordingly, there is a need to improve permitting techniques to address existing challenges by implementing enhancements, such as, increasing transparency and predictability in the permitting process, reducing bureaucratic inefficiencies, and incorporating advanced technologies for better data management and analysis.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system includes a database configured to store spatial data and a server electronically coupled to the database and having a land use permit toolkit implemented on one or more processors coupled to a memory, wherein the land use permit toolkit includes an automation manager and an analytic manager, and wherein the automation manager is configured to obtain a request defining one or more target land use permits and output an electronic command, and wherein the analytic manager is configured to in response to the electronic command associate the one or more target land use permits with spatial data, the spatial data having layer information, geometry information, and element information, construct a permit structure based on at least the geometry information of the spatial data, the permit structure defining permit type, target location, and a period of use for each of the one or more target land use permits, and output a report to a user, the report generated based on the permit structure and having an assignment. In a further embodiment, the land use permit toolkit further includes a geography manager configured to obtain the spatial data from the database. In another further embodiment, the geography manager is configured to index the database to obtain spatial data corresponding to the request. In another further embodiment, the permit structure further defines a status of the one or more target land use permits. In another further embodiment, the permit structure further defines at least one organization associated with the one or more target land use permits. In another further embodiment, the electronic command is further configured to cause the analytic manager to assign the one or more target land use permits to a user associated with the at least one organization. In another further embodiment, the spatial data further includes coordinate information. In another further embodiment, the database is configured to store Oracle data. In another further embodiment, the geometry information indicates a distance between a first land tract associated with each of the one or more target land use permits and a second land tract having a prohibitive layer type. In another further embodiment, the electronic command is further configured to cause the analytic manager to define the permit type based on the distance. In another further embodiment, the system includes at least one user device, the at least one user device having a land use permit tool configured to interface with the land use permit toolkit. In another further embodiment, the user device includes a display and the land use permit tool includes a user-interface configured to enable a user to view at least one of the permit structure and the one or more target land use permits on the display and to make inputs to control the land use permit toolkit.

In another embodiment, a device includes a memory and one or more processors and coupled to the memory, the memory having computer-readable code stored thereon configured to cause the one or more processors to electronically perform the following operations: obtaining a request defining one or more target land use permits, outputting an electronic command, associating the one or more target land use permits with spatial data, the spatial data comprising layer information, geometry information, and element information, constructing a permit structure based on at least the geometry information of the spatial data, the permit structure defining permit type, target location, and a period of use for each of the one or more target land use permits, and outputting, in response to the request, a report to a user, the report generated based on the permit structure and having an assignment.

In a further embodiment, a computer-implemented method includes obtaining a request defining one or more target land use permits, associating the one or more target land use permits with spatial data, the spatial data comprising layer information, geometry information, and element information, constructing a permit structure based on at least the geometry information of the spatial data, the permit structure defining permit type, target location, and period of use for each of the one or more target land use permits, and outputting, in response to the request, a report to a user, the report generated based on the permit structure and having an assignment. In a further embodiment, the method includes assigning the one or more target land use permits to a user associated with at least one organization.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 depicts an example system for implementing enhanced land use permit (LUP) methods, according to one or more aspects provided herein.

FIG. 2 depicts an example flow diagram of an operation of an enhanced LUP system, according to one or more aspects provided herein.

FIG. 3 depicts a diagram of one non-limiting example of a database, according to one or more aspects provided herein.

FIG. 4 depicts a schematic flowchart of an example method, according to one or more aspects provided herein.

FIG. 5 depicts a schematic flowchart of an example method, according to one or more aspects provided herein.

FIG. 6 schematic diagram of an example system, according to one or more aspects provided herein.

FIG. 7 is a block diagram of a computer system that may be used to implement one or more of the systems or methods described herein in accordance with certain aspects.

FIG. 8 depicts a cloud computing environment that can be used to perform one or more actions according to an aspect of the present disclosure.

FIG. 9 is a block diagram of a computer system that may be used to implement one or more of the systems or methods described herein in accordance with certain aspects.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to technological improvements in enhanced procedures for land use permitting.

The process for obtaining a land use permit (LUP) traditionally involves several manual steps for assigning reviewing organizations. These steps may be both time-consuming and prone to error. Aspects provided herein provide the integration of robotic process automation (RPA) with spatial data to streamline LUP processes. According to certain aspects, an RPA may serve to navigate and interact with a land management system, either autonomously or directly through the database. At the direction of the RPA, the land management system may perform complex location-based analysis, which may be crucial for effective LUP decision-making. Accordingly, aspects provided herein can achieve greater efficiency and accuracy. The automated system minimizes delays and errors associated with manual processing, enhances data quality, and reduces the risk of costly errors that have far-reaching consequences.

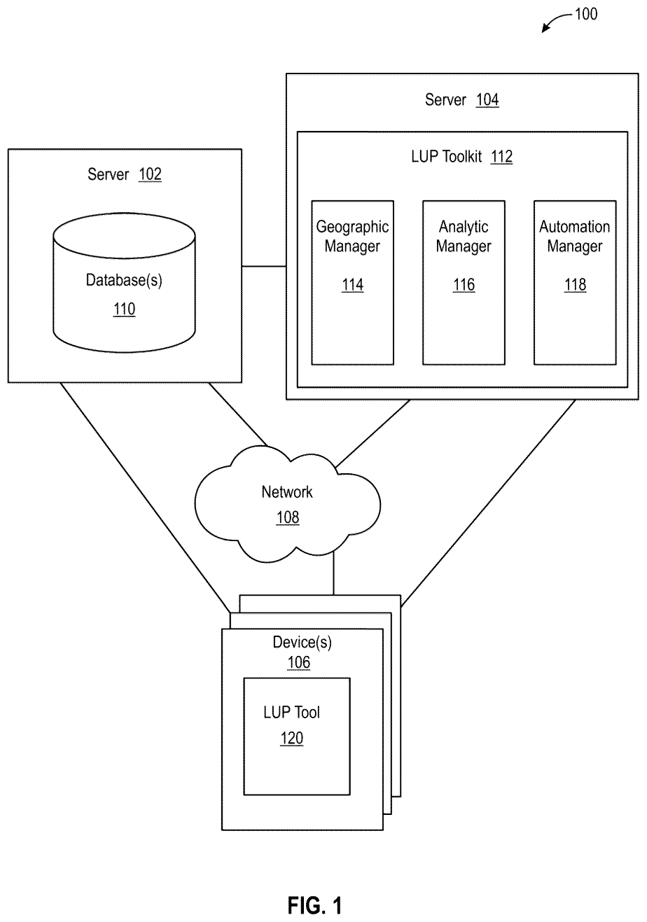

FIG. 1 shows an enhanced LUP system 100, according to one or more embodiments. Enhanced LUP system 100 includes server 102, server 104, and one or more devices 106. Server 102 may include one or more databases 110. Server 104 may include LUP toolkit 112. LUP toolkit 112 may include at least a geographic manager 114, an analytic manager 116, and an automation manager 118. One or more devices 106 may include a LUP tool 120. Server 102, server 104, and one or more devices 106 may communicate using network 108 via communication paths 122a-n.

The enhanced LUP system 100 may be configured to perform a method of enhanced land use permitting, such as steps 500-504 of method 500, described below. For brevity, the method will be described with respect to the components of the system 100. The LUP toolkit 112 may obtain a request defining one or more target land use permits. The LUP toolkit 112 may output, to the analytic manager 116, an electronic command configured to cause the analytic manager 116 to associate the one or more target land use permits with spatial data. The spatial data may include layer information, geometry information, and element information. The electronic command may further cause the analytic manager 116 to construct a permit structure based on at least the geometry information of the spatial data. The permit structure may define a permit type, a target location, and a period of use for each of the one or more target land use permits. The analytic manager may then output, in response to the request, a report to a user, the report generated based on the permit structure and having an assignment.

In at least one aspect, each of servers 102, 104 may have at least one memory and one or more processors having computer readable instructions stored thereon, which are capable of implementing mapping schemes as part of the enhanced mapping architecture. In at least one aspect, servers 102, 104 may have at least one memory and one or more processors having computer readable instructions stored thereon, which are capable of implementing enhanced land use permitting schemes as part of the function of the enhanced mapping architecture. The one or more processor(s) of servers 102, 104 may be central processing units (CPUs). The one or more processor(s) of servers 102, 104 may be graphics processing units (GPUs). Where there is more than one processor, each processor may operate independent from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data. Each of servers 102, 104 may be implemented in a cloud computing environment, such as in a set of containerized applications (e.g., Kubernetes). Alternatively, servers 102, 104 may be implemented on a single dedicated server or workstation.

In at least one aspect, database 110 may be practically implemented as one or more databases. In at least one aspect, the database may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Database 110 may be treated as a data warehouse, data lake, data well, or another storage system. Database 110 may be optimized for querying and analysis, allowing the enhanced data processing architecture methods described herein (e.g., method 400).

In at least one aspect, database 110 may be comprised of spatial data having a hierarchical structure of elements, geometries, and layers. For example, layers are composed of geometries, and geometries are composed of elements. Elements may be points, line strings, polygons, or other structured spatial data types. Geometries may represent a spatial feature as an ordered set of primitive elements and may be an instance of a single element or a homogeneous or heterogenous collection of elements. Layers may be collections of geometries having the same attribute set (e.g., one layer may represent population density), and each layer may have a spatial index. The geometries and associated spatial index for each layer may be stored in the standard tables in the database 110.

In some embodiments, spatial data may be processed at server 102. In one example, processing by server 102 may include spatial indexing to enhance the efficacy of queries between database 110 and server 104 by creating indexes on spatial data types. Processing may further include the execution of queries, facilitating the performance of complex spatial analysis and data retrieval data based on detected spatial relationships. In another example, server 102 may transform and convert data at database 110 between different coordinate systems and/or data formats. In another example, managing and maintaining spatial data within the database. In another example, server 102 may update and/or delete spatial data, and may manage metadata to ensure data integrity.

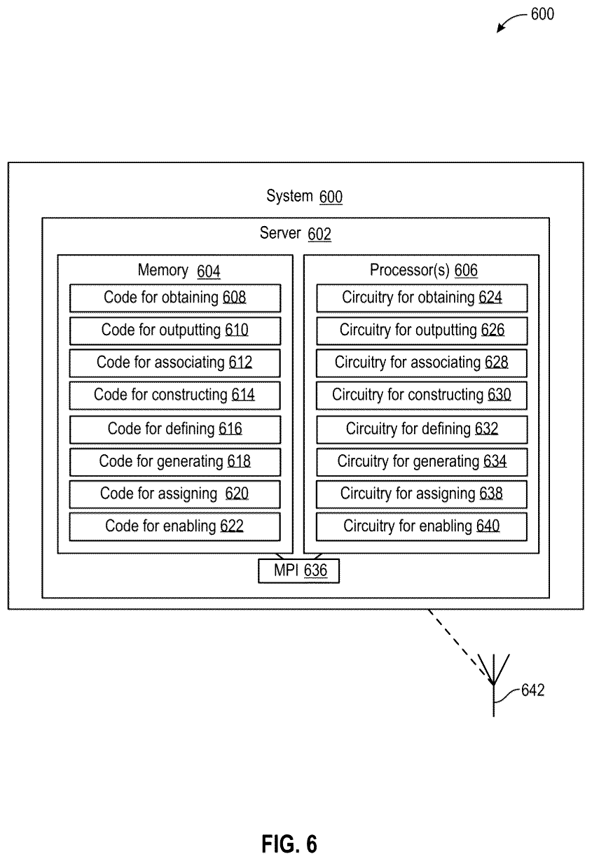

In at least one aspect, LUP toolkit 112 may be an application, such as, an application running under control of an operating system on server 104 or a web application operating which may be accessed via network 108. LUP toolkit 112 may be implemented in software, firmware, hardware or any combination thereof. In at least one aspect, the LUP toolkit 112, including geographic manager 114, analytic manager 116, and automation manager 118, may be implemented on one or more dedicated processors or microprocessors, such as those described with respect to FIG. 6. Processors or microprocessors of the LUP toolkit 112, the geographic manager 114, the analytic manager 116, and the automation manager 118 may be considered similar to FIG. 6, but may encompass different or additional aspects without departing from the scope of the disclosure.

In at least one aspect, LUP toolkit 112 may be accessed by device 106 via network 108. In at least one aspect, device 106 can be any electronic computing device. Device 106 may be a computing device that has a display. A user can enter control inputs through a user interface (such as a keyboard, microphone, or touchscreen). For example, device 106 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 108. In at least one aspect, device 106 may be a remote computing device that includes a permit tool (e.g., LUP tool 120) having a user-interface configured to allow a user to view permit informatics based on a predicted permit table on a display device and to make inputs to control visualization of the permit informatics displayed to the user. In at least one aspect, the LUP tool 120 may be implemented on one or more dedicated processors or microprocessors, such as those described with respect to FIG. 6. Processors or microprocessors of the LUP tool 120 may be considered similar to FIG. 6, but may encompass different or additional aspects without departing from the scope of the disclosure.

In at least one aspect, network 108 may be implemented as one or more networks. Network 108 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IOT) applicability), and the like. Network 108 may be implemented via communication paths 122a-n. Communication paths 122a-n may represent communicative coupling between each and any component enhanced LUP system 100.

In at least one aspect, device 106 may be in communication with a database stored on a web server (e.g., server 102), such as a web server associated with a land management website. Device 106 send an input that is received by server 104 through communication paths 120a-n of the network 110. For example, a user may input a request for a target LUP on device 106, the input including parameters such as target site of the land, target use of the land, and target time period of use of the land. The target site may be represented by geographic information such as geographic coordinates. The request may be communicated to and received by the web server, such as one hosted by a relevant land management website. In at least one aspect, the web server contains a database for storing requests for target LUPs. The web server database may be a relational database management system (RDBMS).

In at least one aspect, the automation manager 118 orchestrates the communication and functionality of server 104. Automation manager 118 may autonomously navigate and interact with server 102 over communication paths 120a-n. In other aspects, automation manager 118 may directly communicate with database 110 of server 102. The automation manager 118 may receive requests for target LUPs from the device 106 or may identify requests on server 102 and may issue commands to the geographic manager 114 and construct queries for the analytic manager 116 to process.

In one example, a query includes the input parameters of the request, including target site of the land, target use of the land, and target time period of use of the land. The geographic manager 114 and the analytic manager 116 communicate and function in tandem so that the analytic manager 116 can process the queries and return decision values. Decision values may include a LUP report. A LUP report may include or be associated with a permit structure. The automation manager 118 may communicate the report provided by the analytic manager 116 to the device 106 or server 102. In one example, the report indicates at least one responsible permitting organization. In such examples, the automation manager 118 assigns the report the responsible permitting organization for the organization to review.

In at least one aspect, server 104 may contain a geographic information system (GIS) application that can store, retrieve, manipulate, and display data related to positions of the Earth's surface, such as spatial data stored in database 110. Geographic manager 114 may communicate directly with database 110, and may retrieve relevant spatial data from database 110 in response to a command from the automation manager 118. In some aspects, server 104 stores the retrieved spatial data in memory. In other aspects, server 104 is pre-configured with spatial data such that the geographic manager 114 can display and manipulate spatial data without a command from the automation manager 118 to retrieve data from database 110.

In at least one aspect, the analytic manager 116 communicates directly with the automation manager 118 and the geographic manager 114. The analytic manager 116 may process queries constructed and provided by the automation manager 118 by performing spatial querying of the spatial data (e.g., Oracle spatial data) retrieved by the geographic manager 114 and may additionally perform spatial operators, procedures, and functions of the queried data. In at least one aspect, the analytic manager 116 displays, manipulates, and analyzes relevant spatial data using spatial operators, procedures and functions. In one example, the analytic manager 116 describes the operational interface of a GIS application. In at least one aspect, the analytic manager 116 may produce a target land use report characterized by the manipulation and analysis of the spatial data.

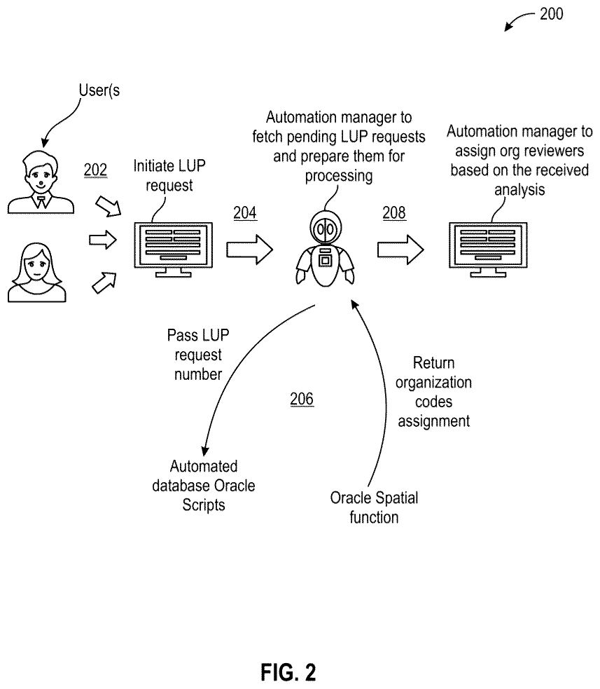

FIG. 2 is a flow diagram of operation of an enhanced LUP system 200, which may be similar or the same as enhanced LUP system 100 in at least one non-limiting example. At operation 202, a user may send a request for a target LUP to a server having or compatible with an LUP toolkit (e.g., LUP toolkit 112). In one example, the user may input the request on a device (e.g., one or more devices 106) in communication with the server. In such examples, the device 106 may include an interface for interaction with the toolkit, such as an application, which may be configured to receive user inputs and communicate the user inputs to the server.

At operation 204, the server may initiate the target LUP request, such as by storing the request in a server database or server memory. The server may label the inbound request as “pending”. An RPA (e.g., automation manager 118) may fetch the pending LUP request from the server and prepare the request for processing. Preparing the request for processing may include constructing queries based on input parameters provided in the request or relaying input parameters to one or more processors responsible for querying. Preparing the request for processing may also include retrieving queried data from a database or relaying a command to one or more processors responsible for retrieving queried data from a database.

The RPA, alone or in combination with one or more processors (e.g., processors at the geographic manager 114 and/or the analytic manager 116) may process the request at operation 206, such as by running automated scripts for analyzing the retrieved data, including but not limited to performing Oracle Spatial Functions. Once the data is processed, a set of values corresponding to decisions may be returned. The set of values may correspond to a permit structure. In at least one aspect, the permit structure is based on the data processing steps. In at least one aspect, the permit structure is based on a default permit schedule. In one example, the permit structure may be compiled into a report. In at least one aspect, the report indicates at least one organization responsible for reviewing the report, including the returned decision values.

Once returned either by the one or more processors or the RPA, the RPA may assign the permit structure to the at least one organization at operation 208. In one example, the RPA relays the report to the server, whereby the server stores the values in the database. The assignment may be coded into or associated with the permit structure such that an organization accessing the server can easily view any reports or decisions it is responsible for reviewing. In another example, the RPA directly communicates with the responsible organization.

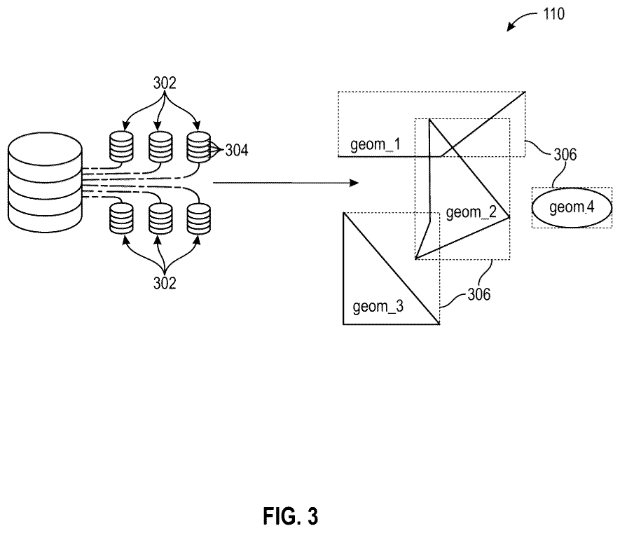

FIG. 3 is a diagram of one non-limiting example of a database 110 shown in further detail. In at least one aspect, database 110 may include a plurality of tables 302, each table comprising a plurality of records 304, and each record 304 comprising a plurality of fields. The fields may store various types of data, such as integers, floating-point numbers, strings, dates, and/or binary data. Database 110 may be configured to store and manage data related to specific spatial elements. For example, database 110 may store data as a hierarchical structure of features, including elements, geometries, and layers, as described above. In at least one aspect, the spatial data is associated with coordinate systems, allowing spatial features to be related to a location. In one example, the coordinate systems can be georeferenced (e.g., related to a specific representation of the Earth). In other examples, coordinate systems are not georeferenced (e.g., Cartesian coordinates). In some examples, database 110 is implemented as a relational database management system (RDBMS), such as an object-relational model.

In one non-limiting example, database 110 may leverage Oracle Spatial's support for an object-relational model to represent geometries 306. This system may store an entire geometry 306 associated with a target land area in Oracle's native spatial data type, “SDO-GEOMETRY.” SDO-GEOMETRY may include vector geometries such as points, lines, and polygons, and “SDO_POINT_TYPE” for point geometries. Complex geometries are defined using “SDO_ELEM_INFO_A7AY” and “SDO_ORDINATE_A7AY.” These data types enable the storage and manipulation of spatial data within the Oracle Database environment. An Oracle table can be configured to contain one or more columns of the SDO-GEOMETRY type, facilitating the storage and manipulation of complex spatial data. The object-relational model employed may correspond to an “SQL with Geometry types” implementation. Accordingly, an object-relational model for Oracle Spatial may utilize SQL operators for spatial analysis. For example, operators such as “SDO_WITHIN_DISTANCE” and “SDO_RELATE” may be useful to determine spatial relationships and proximity between geometries 306.

The database 110 may be accessed and manipulated using a structured query language (SQL). SQL statements may be used to perform various operations on the data, such as querying, inserting, updating, and deleting records. The database 110 may also support advanced features such as indexing, filtering, and spatial relating or programming to accurately and efficiently analyze and process LUP requests.

In another non-limiting example, the database 110 may be implemented as a NoSQL database. The NoSQL database may be designed to handle large volumes of unstructured or semi-structured data. The NoSQL database may use various data models, such as key-value pairs, document-oriented, column-family, or graph-based models, to store and manage data. The NoSQL database may provide high scalability and flexibility, allowing it to handle large-scale data storage and processing requirements. The NoSQL database may support distributed data storage and processing, enabling it to operate efficiently across multiple servers or data centers. In some aspects, the geographic manager 114 may convert unstructured or semi-structured data from the NoSQL database to structured data, which may be stored, in other aspects, in a SQL database.

Upon receiving a request for a LUP, spatial data associated with the request may be retrieved or queried by the geographic manager 114. The request may include information on the target site of the land, target use of the land, and target time period of use of the land. In an aspect, information on the target site of the land may be coordinates, such as geographic coordinates having latitude and longitude values, which may serve as a georeference for querying and retrieving associated (relevant) spatial data from database 110. In addition, spatial data of relevant permitting organizations may be queried and retrieved from the database 110 by the geographic manager 114. Alternatively, spatial data of relevant permitting organizations may be stored in the memory of server 104 or may be retrieved elsewhere, such as from the database of server 102.

Once the relevant spatial data has been retrieved, server 104 will execute (perform) functions or operations on the spatial data to determine whether the site or features of the target land intersect with the site or features of the relevant permitting organization by using spatial querying and spatial functions to organize and analyze the retrieved spatial data from database 110. The functions or operations may be performed by one or more processors of server 104, such as the processor of the analytic manager 116.

In at least one aspect, the analytic manager 116 may perform relational and contingent operations to evaluate constraints pertinent to the type of permit requested and the specified period of use. These constraints may include zoning regulations, environmental protections, and land use designations. These operations may be performed prior to, concurrent with, or after spatial intersections have been identified. Spatial functions may facilitate the execution of these relational and contingent operations, such as determining proximity to protected areas, overlay analysis with zoning maps, and temporal constraints based on the permit's duration. The results of these queries will be used to assess the compliance of the land use request with applicable regulations, ensuring that the permit is granted only if all criteria are satisfactorily met. These features may constitute one or more technical improvements over conventional permitting operations by implementing temporarily overlapping relational and contingent operations with spatial operations.

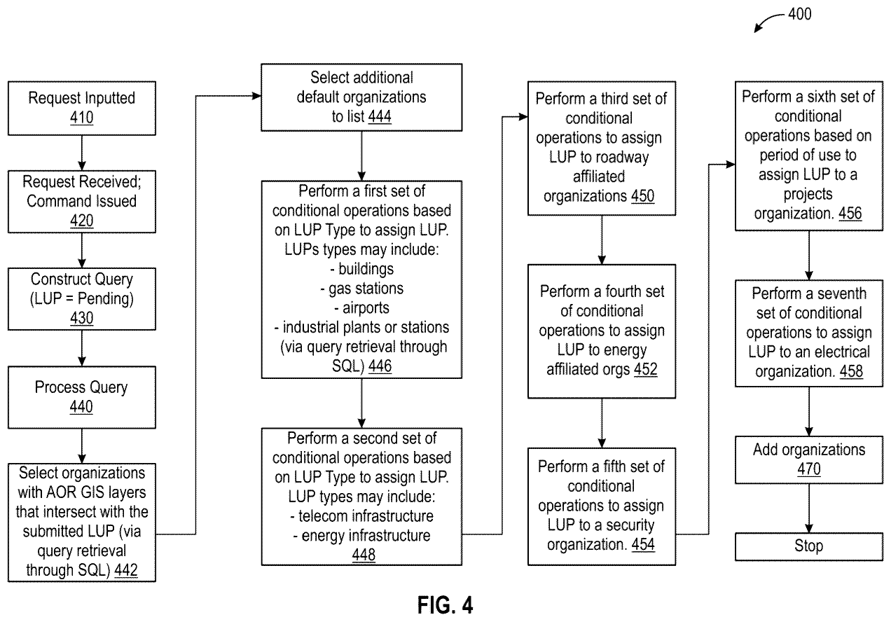

FIG. 4 illustrates a schematic flowchart of an example method 400 for generating a permit structure, implemented by an enhanced land user permit architecture. In non-limiting examples, enhanced LUP architectures 100 (FIGS. 1) and 200 (FIG. 2) may be implemented using method 400 according to aspects provided herein (steps 410-470). Accordingly, the method 400 may be best understood with reference to operation of the enhanced LUP system 100, with like numerals designating the same or similar elements.

The method 400 begins at operation 410, with a user inputting a request for a target LUP. In at least one aspect, the request may be placed at the device 106. The request may include target land use information, including but not limited to geographic information of the target land, such as coordinates of the target land, target land use type, such as the type of building desired to be built, and the period of use. The request may be received by one or more processors of server 104.

The method 400 continues at operation 420, with the automation manager 118 issuing a command based on the target LUP request. At operation 420, the LUP request may be pending. The command may instruct the geographic manger 114 to query and retrieve spatial data corresponding to the geographic information of the target land. In at least one aspect, the geographic manager 114 may retrieve the corresponding spatial data from the database 110 and store the spatial data in the memory of server 104 upon receiving the command from the automation manager 118.

In at least one aspect, the method 400 may include an operation by the geographic manager 114 to query and retrieve spatial data of at least one permitting organization, or “organizational spatial data”. The organizational spatial data may comprise features such as layers, geometries, or elements to represent a particular region, jurisdiction, or Area of Responsibility (AOR) associated with the permitting organization and may be georeferenced with a coordinate system. The organizational spatial data may also comprise one or more spatial or temporal relationships associated with the spatial data.

In one example, the spatial data of the permitting organization may be stored within the memory of the server 104. In other examples, the spatial data may be stored in a separate database, such as database 110. In more examples, the spatial data may be stored on the device 106 or on the network 108 using dedicated storage devices, such as network-attached storage (NAS).

The method 400 continues at operation 430, with the automation manager 118 constructing a query based on the request and sending the query to analytic manager 116 for processing. The query may include input parameters corresponding to the target land use information of the request, including the geographic information, the land use type, and the period of use.

The method 400 continues at operation 440, with the analytic manager 116 processing the query. In at least one aspect, the analytic manager 116 may process the query by performing one or more spatial functions or operations using the spatial data aggregated and retrieved by the geographic manager 114. In at least one aspect, the processing operation 440 makes one or more LUP decisions and outputs decision values based on the one or more LUP decisions. The decision values may be represented as a matrix of Booleans, enumerated types, integers, characters, strings, bits, etc.

In one example, the analytic manager 116 performs a spatial function whereby one or more processors evaluate whether the spatial data intersects with the GIS features of the permitting organization 442 to determine whether the spatial data falls within an AOR of permitting organization. In other examples, spatial functions are used to find intersections of the spatial data with one or more permitting parameters associated with the GIS features. In at least one aspect, the analytic manager 116 constructs a distance value based on spatial data from the geographic manager 114, the spatial data having layer-geometry-element structure. In one example, implementation of the analytic manager 116 may operate integrated with or in conjunction with the geographic manager 114 to facilitate enhanced spatial and/or distance operations at server 104. Specifically, spatial querying between the geographic manager 114 and the analytic manager 116 may facilitate the performance of seamless distance operations. This includes tasks such as buffering, distance comparison, and complex location-based analysis, which are crucial for effective LUP decision-making. In another aspect, the analytic manager 116 selects additional default organizations 444, with or without performing any data processing.

In more examples, the analytic manager 116 may perform relational or contingent spatial functions when other input parameters are triggered. For example, when a user inputs a request to build an office on a particular tract of land, the analytic manager 116 may process the associated query from the automation manager 118 by constraining the spatial data of the permitting organizations to only relevant permitting organizations. These features may constitute one or more technical improvements over conventional permitting operations by implementing analytic manager 116 to process queries associated with spatial, GIS, and other structured data types. In addition, the automation manager 118, the geographic manager 114, and the analytic manager 116 may interface to yield conditional outputs based on a set of input parameters and permitting parameters.

More specifically, the analytic manager 116 may perform sets of conditional operations based on LUP type to determine whether to assign the LUP to a relevant permitting organization. Relevant permitting organizations may be determined via query retrieval through SQL. A first set of conditional operations 446 depends on a first set of LUP types, including buildings, gas stations, airports, or industrial plants or stations. A second set of conditional operations 448 depends on a second set of LUP types, including telecom infrastructure and energy infrastructure. A third set of conditional operations 450 depends on a third set of LUP types, including road-way affiliated organizations. A fourth set of conditional operations 452 depends on a fourth set of LUP types, including energy-affiliated organizations. A first fifth of conditional operations 454 depends on a fifth set of LUP types, including security organizations. A sixth set of conditional operations 456 depends on a sixth set of LUP types, including projects organizations. A seventh set of conditional operations 458 depends on a seventh set of LUP types, including electrical organizations.

The method 400 continues at operation 470, with the analytic manager 116 selecting and adding organizations and returning a report including a list of organizations based on the processed request. In one example, the returned list of organizations may be a pared down list of relevant organizations from a comprehensive list of organizations contained in and associated with the spatial data. In at least one aspect, the automation manager 118 assigns the returned report to the relevant organizations provided in the list. These features may constitute one or more technical improvements over conventional permitting operations by implementing 118 to automate 116, removing the need for redundant operations.

### Example Methods

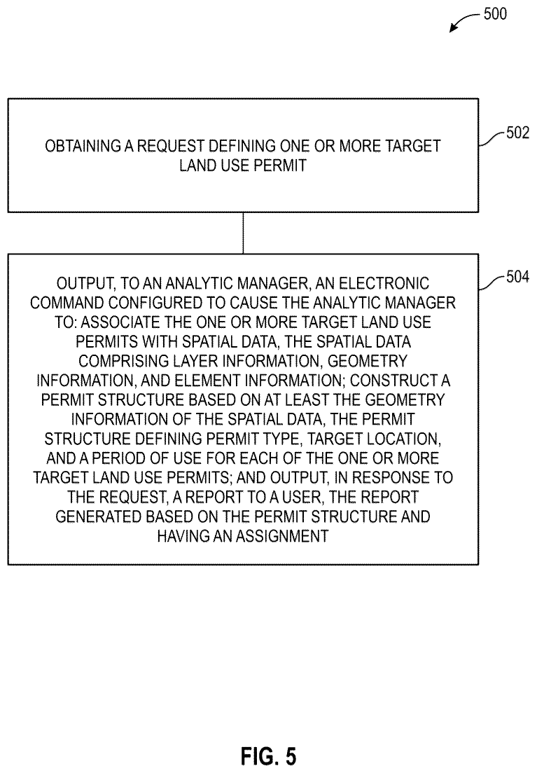

FIG. 5 is a schematic flowchart of an example method 500 for enhanced land use permitting by one or more processors, such as processors of enhanced LUP architectures 100 of FIG. 1, processors of enhanced LUP architectures 200 of FIG. 2, and/or the processors of the system 600 of FIG. 6.

Method 500 begins at operation 502 with one or more processors obtaining at least one request from one or more computing devices (e.g., device 106). The at least one request may define one or more target LUPs.

Method 500 continues to operation 504 with one or more processors, in response to the request by the one or more users, outputting a command to the one or more processors to generate a permit structure based on the request.

In at least one aspect, method 500 may include an operation by one or more processors to assign the one or more target LUPs to at least one organization.

Operation 504 may include one or more processors obtaining spatial information associated with the request. In one example, spatial information is generated by one or more databases. The one or more databases may be at a second unit, such as database 110 of FIG. 1 or a database 110 of FIG. 3. In another example, spatial information is stored as Oracle data.

Operation 504 may include one or more processors constructing a permit structure based on at least geometry information of the spatial information. In one example, the geometry information indicates a distance between a first land tract associated with each of the one or more target LUPs and a second land tract having a prohibitive layer type. In at least one aspect, the constructing a permit structure may also be based on coordinate information of the spatial information.

In one example, the permit structure defines a permit type, a target location, and a period of use of the one or more target LUPs. In another example, the permit structure further defines a status of the one or more target LUPs. In yet another example, the permit structure defines the at least one organization.

In at least one aspect, constructing a permit structure further defines the permit type based on the distance indicated by the geometry information (e.g., the distance between a first land tract associated with each of the one or more target LUPs and a second land tract having a prohibitive layer type).

Operation 504 may include one or more processors outputting the permit structure. In one example, operation 504 outputs the permit structure to a display on the one or more users at the one or more computing devices (e.g., device 106).

In at least one aspect, the method 500 may include an operation by one or more processors to control the command of operation 504 in response to one or more inputs by one or more users one or more users at the one or more computing devices.

### Further Features and Advantages

As described above, system 100 and method 500 provide a number of features and technical advantages. For example, the enhanced Land Use Permitting (LUP) system 100 offers several significant advantages over traditional manual processes. By integrating Robotic Process Automation (RPA) with spatial data, the system streamlines the LUP process, reducing the time and errors associated with manual steps. The RPA navigates and interacts with the land management system autonomously, performing complex location-based analyses crucial for effective decision-making. This automation enhances efficiency and accuracy, minimizes delays, and improves data quality, thereby reducing the risk of costly errors.

Additionally, the system's architecture, which includes servers, databases, and various management tools, allows for robust data processing and analysis. The LUP toolkit 112 facilitates the retrieval, manipulation, and analysis of spatial data. This comprehensive approach ensures that all relevant spatial and regulatory information is considered, leading to more informed and compliant permitting decisions. The system's ability to handle various data types and perform advanced spatial functions further enhances its technical and practical utility in land use permitting.

### Example Systems

FIG. 6 illustrates a schematic diagram of an example system 600, which includes a device 602. The system 600 may be implemented as part of the LUP procedures described with respect to FIGS. 1-5. The server 602 may be implemented at a single location or at multiple locations and may be a supervisory server or may be in communication with a supervisory server by way of a communication line. In at least one embodiment, the communication line may be a wireless communication line, a wired communication line, or both, though other types of communication line are contemplated.

The server 602 may include a CPU processing system, which may be configured to perform enhanced LUP procedures, such as those described herein with respect to FIG. 1-5, as performed by the system 600. The CPU processing system of the server 602 may include one or more processors 606 coupled to a computer readable medium/memory 604, for example via a bus (not shown). The one or more processors 606 and the computer readable medium/memory 604 may communicate via a message passing interface (MPI) 636. In certain aspects the computer readable medium/memory 604 is configured to store instructions (e.g., computer executable code) that when executed by the one or more processors 606, cause the one or more processors to perform the method 500 described with respect to FIG. 5, or any aspect related to it. Reference to a single processor performing a function of system 600 may include one or more processors performing that function of system 600.

In the depicted example, computer-readable medium/memory 604 stores code (e.g., executable instructions) for obtaining 608, code for outputting 610, code for associating 612, code for constructing 614, code for defining 616, code for generating 618, code for assigning 620, code for enabling 622. Processing of code 608-622 may cause the system 600 to perform the method 500 described with respect to FIG. 5, or any aspect related to it.

The one or more processors 606 include circuitry configured to implement (e.g., execute) the code stored in the computer-readable medium/memory 604, including circuitry for obtaining 624, circuitry for outputting 626, circuitry for associating 628, circuitry for constructing 630, circuitry for defining 632, circuitry for generating 634, circuitry for assigning 638, circuitry for enabling 640. Processing with circuitry 624-634, 638-640 may cause the system 600 to perform the method 500 described with respect to FIG. 5, or any aspect related to it.

Various components of the system 600 may provide means for performing the method 500 described with respect to FIG. 5, or any aspect related to it.

The system 600 may include or be substantially coupled to a communication component 642. In the depicted example, the communication component 642 is an antenna capable of communicating with controllers similar to system 600 to perform the method 500 described with respect to FIG. 5, or any aspect related to it. In additional examples, the communication component 642 may be a bus or a wired connection.

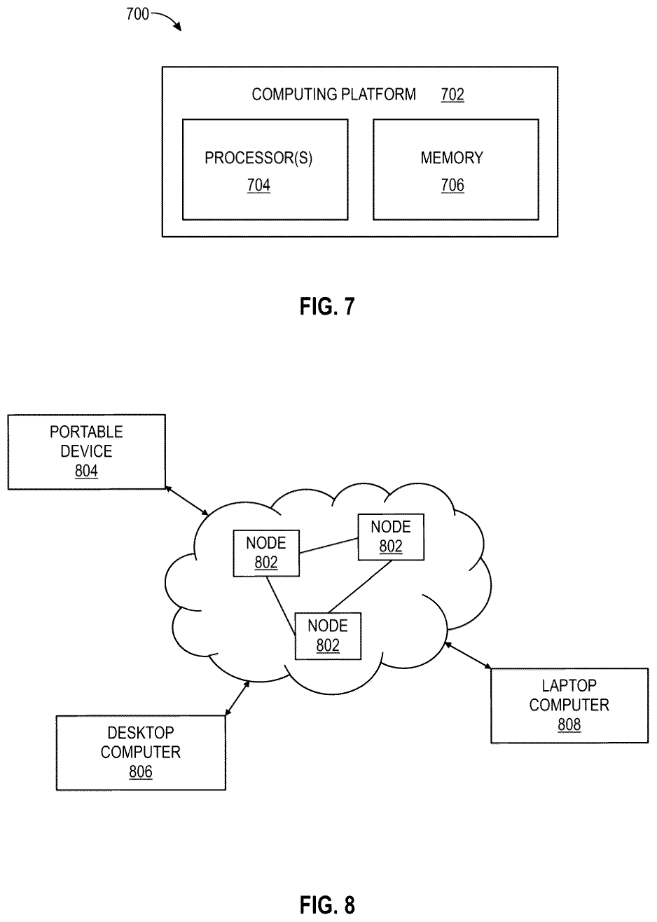

FIG. 7 is an example of a block diagram of a system 700. The system 700 can be implemented using one or more modules, shown in block form in the drawings. The one or more modules can be in software or hardware form, or a combination thereof. In some examples, the system 700 can be implemented as machine readable instructions for execution on one or more computing platforms 702 (referred to as a computing platform herein), as shown in FIG. 7. The computing platform 702 can include one or more computing devices selected from, for example, a desktop computer, a server, a controller, a blade, a mobile phone, a tablet, a laptop, a personal digital assistant (PDA), and the like.

The computing platform 704 can include a processor 704 and a memory 706. By way of example, the memory 706 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 704 can be implemented, for example, as one or more processor cores. The memory 706 can store machine-readable instructions that can be retrieved and executed by the processor 704 to implement the system 700. Each of the processor 704 and the memory 706 can be implemented on a similar or a different computing platform. The computing platform 702 can be implemented in a cloud computing environment (for example, as disclosed herein) and thus on a cloud infrastructure. In such a situation, features of the computing platform 702 can be representative of a single instance of hardware or multiple instances of hardware executing across the multiple of instances (e.g., distributed) of hardware (e.g., computers, routers, memory, processors, or a combination thereof). Alternatively, the computing platform 702 can be implemented on a single dedicated server or workstation.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

FIG. 8 is an example of a cloud computing environment 800 that can be used for implementing one or more modules and/or systems in accordance with one or more examples, as disclosed herein. Thus, reference can be made to one or more examples of FIGS. 1-9 in the example of FIG. 8. As shown, cloud computing environment 800 can include one or more cloud computing nodes 802 with which local computing devices used by cloud consumers (or users), such as, for example, personal digital assistant (PDA), cellular, or portable device 804, a desktop computer 806, and/or a laptop computer 808, may communicate. The computing nodes 802 can communicate with one another, In some examples, the computing nodes 802 can be grouped (not shown) physically or virtually, in one or more networks, such as Private, Community, Public, or Hybrid clouds, or a combination thereof. This allows the cloud computing environment 800 to offer infrastructure, platforms and/or software as services for which a cloud consumer does not need to maintain resources on a local computing device. The devices 804-808, as shown in FIG. 8, are intended to be illustrative and that computing nodes 802 and cloud computing environment 800 can communicate with any type of computerized device over any type of network and/or network addressable connection (e.g., using a web browser). In some examples, the one or more computing nodes 802 are used for implementing one or more examples disclosed herein relating to root-source identification. Thus, in some examples, the one or more computing nodes can be used to implement modules, platforms, and/or systems, as disclosed herein.

In some examples, the cloud computing environment 800 can provide one or more functional abstraction layers. It is to be understood that the cloud computing environment 800 need not provide all of the one or more functional abstraction layers (and corresponding functions and/or components), as disclosed herein. For example, the cloud computing environment 800 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 800 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 800 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 800, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 800 for consumers and system administrators. The management layer can also provide service level management, which can provide cloud computing resource allocation and management such that required service levels are met, Service Level Agreement (SLA) planning and fulfillment can also be provided to provide pre-arrangement for, and procurement of, cloud computing resources for which a future requirement is anticipated in accordance with an SLA.

In some examples, the cloud computing environment 800 can provide a workloads layer that provides examples of functionality for which the cloud computing environment 800 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 800.

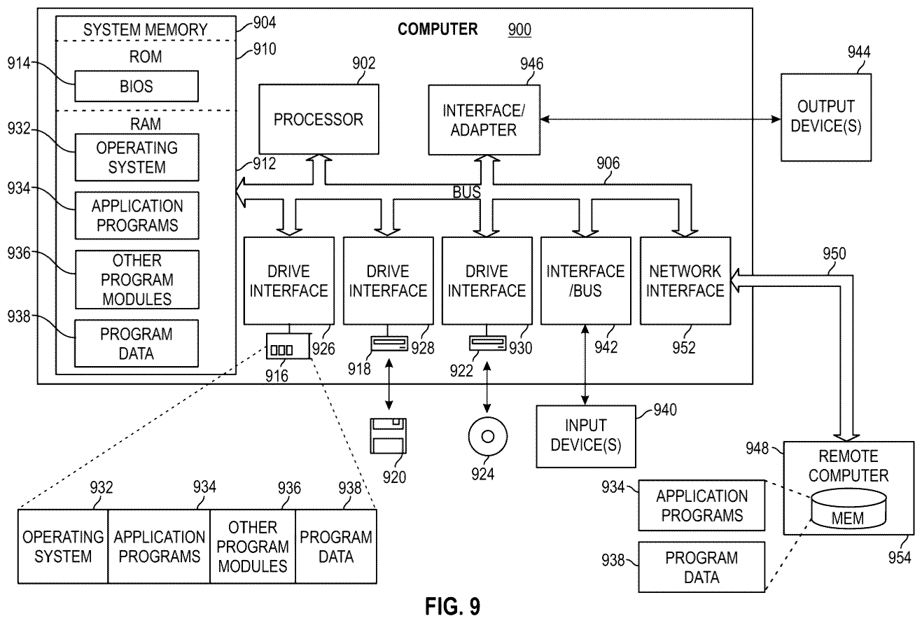

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 9. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 9 illustrates one example of a computer system 900 that can be employed to execute one or more embodiments of the present disclosure. Computer system 900 can be implemented on one or more general purpose networked computer systems, embedded computer systems, routers, switches, server devices, client devices, various intermediate devices/nodes or standalone computer systems. Additionally, computer system 900 can be implemented on various mobile clients such as, for example, a personal digital assistant (PDA), laptop computer, pager, and the like, provided it includes sufficient processing capabilities.

Computer system 900 includes processing unit 902, system memory 904, and system bus 906 that couples various system components, including the system memory 904, to processing unit 902. System memory 904 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 902. System bus 906 may be any of several types of bus structure including a memory bus or memory controller, a peripheral bus, and a local bus using any of a variety of bus architectures. System memory 904 includes read only memory (ROM) 910 and random access memory (RAM) 912. A basic input/output system (BIOS) 914 can reside in ROM 910 containing the basic routines that help to transfer information among elements within computer system 900.

Computer system 900 can include a hard disk drive 916, magnetic disk drive 918, e.g., to read from or write to removable disk 920, and an optical disk drive 922, e.g., for reading CD-ROM disk 924 or to read from or write to other optical media. Hard disk drive 916, magnetic disk drive 918, and optical disk drive 922 are connected to system bus 906 by a hard disk drive interface 926, a magnetic disk drive interface 928, and an optical drive interface 930, respectively. The drives and associated computer-readable media provide nonvolatile storage of data, data structures, and computer-executable instructions for computer system 900. Although the description of computer-readable media above refers to a hard disk. a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 900 may operate in a networked environment using logical connections to one or more remote computers, such as remote computer 948. Remote computer 948 may be a workstation, computer system, router, peer device, or other common network node, and typically includes many or all the elements described relative to computer system 900. The logical connections, schematically indicated at 950, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 900 can be connected to the local network through a network interface or adapter 952. When used in a WAN networking environment, computer system 900 can include a modem, or can be connected to a communications server on the LAN. The modem, which may be internal or external, can be connected to system bus 906 via an appropriate port interface, In a networked environment, application programs 934 or program data 938 depicted relative to computer system 900, or portions thereof, may be stored in a remote memory storage device 954.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

### Example Aspects

Implementation examples are described in the following numbered clauses:
Aspect 1: A system comprising a database configured to store spatial data, and a remote server electronically coupled to the database and having a land use permit toolkit, the land use permit toolkit comprising an automation manager having one or more processors coupled to a memory and configured to electronically perform: obtaining a request defining one or more target land use permits, and outputting, to an analytic manager, an electronic command configured to cause the analytic manager to: associate the one or more target land use permits with spatial data, the spatial data comprising layer information, geometry information, and element information, construct a permit structure based on at least the geometry information of the spatial data, the permit structure defining permit type, target location, and a period of use for each of the one or more target land use permits, and output, in response to the request, a report to a user, the report generated based on the permit structure and having an assignment.
Aspect 2: The system of aspect 1, wherein the land use permit toolkit further comprises a geography manager configured to obtain the spatial data from the database.
Aspect 3: The system of any one of aspects 1 and 2, wherein the permit structure further defines a status of the one or more target land use permits.
Aspect 4: The system of any one of aspects 1 through 3, wherein the permit structure further defines at least one organization of the one or more target land use permits.
Aspect 5: The system of aspect 4, wherein the electronic command is further configured to cause the analytic manager to assign the one or more target land use permits to a user associated with the at least one organization.
Aspect 6: The system of any one of aspects 1 through 5, wherein the spatial data further includes coordinate.
Aspect 7: The system of any one of aspects 1 through 6, wherein the database is configured to store Oracle data.
Aspect 8: The system of any one of aspects 1 through 7, wherein the geometry information indicates a distance between a first land tract associated with each of the one or more target land use permits and a second land tract having a prohibitive layer type.
Aspect 9: The system of aspect 8, wherein the electronic command is further configured to cause the analytic manager to define the permit type based on the distance.
Aspect 10: The system of any one of aspects 1 through 9, wherein the database is at a second remote server.
Aspect 11: The system of any one of aspects 1 through 10, further including at least one user device, the at least one user device having a land use permit tool configured to interface with the land use permit toolkit.
Aspect 12: The system of any one of aspects 1 through 11, the land use permit tool configured to having a user-interface configured to enable a user to view at least one of the permit structure and the one or more target land use permits on a display device and to make inputs to control the land use permit toolkit.
Aspect 13: A device, including a memory and one or more processors and coupled to the memory, the memory having computer-readable code stored thereon configured to cause the one or more processors to electronically perform: obtaining a request defining one or more target land use permits; and outputting, to an analytic manager, an electronic command configured to cause the analytic manager to: associate the one or more target land use permits with spatial data, the spatial data including layer information, geometry information, and element information, construct a permit structure based on at least the geometry information of the spatial data, the permit structure defining permit type, target location, and a period of use for each of the one or more target land use permits, and output, in response to the request, a report to a user, the report generated based on the permit structure and having an assignment.
Aspect 14: A method, including obtaining a request defining one or more target land use permits, and outputting, to an analytic manager, an electronic command configured to cause the analytic manager to: associate the one or more target land use permits with spatial data, the spatial data including layer information, geometry information, and element information, construct a permit structure based on at least the geometry information of the spatial data, the permit structure defining permit type, target location, and period of use for each of the one or more target land use permits, and output, in response to the request, a report to a user, the report generated based on the permit structure and having an assignment.
Aspect 15: The method of aspect 14, further including assigning the one or more target land use permits to a user associated with at least one organization.
Aspect 16: An apparatus or device including a memory including executable instructions, and a processor configured to execute the executable instructions and cause the apparatus to perform a method in accordance with any one of aspects 1-15.
Aspect 17: An apparatus or device, including means for performing a method in accordance with any one of aspects 1-15.
Aspect 18: A non-transitory computer-readable medium including executable instructions that, when executed by a processor of an apparatus, cause the apparatus to perform a method in accordance with any one of aspects 1-15.
Aspect 19: A computer program product embodied on a computer-readable storage medium including code for performing a method in accordance with any one of aspects 1-15.

The present disclosure may be a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

“Real-time” may refer to the capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A system, comprising:
a land use permit toolkit implemented by a processor executing instructions stored in a memory, the land use permit toolkit comprising:
an automation manager configured to construct queries based on a land use permit (LUP) request, wherein the LUP request includes a target site of a land, a target use of the land, and a target time period of use of the land;
the automation manager is further configured to relay a command to a geographic manager to query and retrieve spatial data from one or more databases of at least one permitting organization, wherein the at least one permitting organization is an organization relevant to the target site of the land;
the geographic manager is further configured to perform one or more computations on the retrieved spatial data to determine whether one or more features of the target site of a land intersects with one or more features of the at least one permitting organization;
an analytic manager configured to perform seven sets of conditional operations using the LUP request and the retrieved spatial data to determine a relevant permitting organization to assign the LUP request to;
the analytic manager is further configured to:
generate an LUP report associated with a permit structure, wherein the permit structure is based on geometry information of the retrieved spatial data, and the permit structure defines one or more permit types, the target site of a land, a period of use of one or more target land use permits, and at least one organization responsible for reviewing the LUP report;
the land use permit toolkit is further configured to send, via a network, the LUP report to the at least one organization responsible for reviewing the report; and
output the LUP report to a user.

2. (canceled)

3. The system of claim 1, wherein the geographic manager is further configured to index the database to obtain spatial data corresponding to the LUP request.

4. The system of claim 1, wherein the permit structure further defines a status of the one or more target land use permits.

5. (canceled)

6. The system of claim 1, wherein the land use permit toolkit is further configured to output an electronic command to cause the analytic manager to assign the one or more target land use permits to a user associated with the at least one permitting organization.

7. The system of claim 1, wherein the one or more databases further comprises coordinate information of the spatial data.

8. The system of claim 1, wherein the one or more databases are configured to store Oracle data.

9. The system of claim 1, wherein the geographical manager is further configured to retrieve geometry information that indicates a distance between a first land tract associated with each of the one or more target land use permits and a second land tract having a prohibitive layer type.

10. The system of claim 6, wherein the electronic command is further configured to cause the analytic manager to associate the one or more target land use permits with spatial data.

11. The system of claim 1, further comprising at least one user device, the at least one user device having a land use permit tool configured to interface with the land use permit toolkit.

12. The system of claim 11, wherein the user device includes a display and the land use permit tool includes a user-interface configured to enable a user to view at least one of the permit structure and the one or more target land use permits on the display and to make inputs to control the land use permit toolkit.

13. A device, comprising:
a memory; and
one or more processors electronically coupled to the memory, the memory having computer-readable code stored thereon configured to cause the one or more processors to perform the following operations:
receiving a request defining one or more target land use permits (LUP), wherein the LUP request includes a target site of a land, a target use of the land, and a target time period of use of the land;
outputting a command to query and retrieve spatial data from one or more databases of at least one permitting organization, wherein the at least one permitting organization is an organization relevant to the target site of the land;
performing, via the geographic manager, one or more computations on the retrieved spatial data to determine whether one or more features of the target site of a land intersects with one or more features of the at least one permitting organization using;
sending an electronic command to associate the one or more target land use permits with spatial data, the spatial data comprising layer information, geometry information, and element information;
constructing a permit structure based on at least the geometry information of the spatial data, wherein the permit structure defines a permit type, target location, and a period of use for each of the one or more target land use permits;
outputting, in response to the request, a report to a user, the report is generated based on the permit structure and includes an assignment to at least one of the permitting organization; and
sending, via a network, the report to an organization responsible for reviewing the report.

14. A computer-implemented method, comprising:
constructing, via an automation manager implemented by one or more processors, queries based on a land use permit (LUP) request, wherein the LUP request includes a target site of a land, a target use of the land, and a target time period of use of the land;
relaying a command, via the automation manager, to a geographic manager to query and retrieve spatial data from at least one or more databases of at least one permitting organization, wherein the at least one permitting organization is an organization relevant to the target site of the land;
storing the retrieved spatial data a memory;
performing, via the geographic manager, one or more computations on the retrieved spatial data to determine whether one or more features of the target site of a land intersects with one or more features of the at least one permitting organization;
performing, via an analytical manager, seven sets of conditional operations using the LUP request and the retrieved spatial data to determine which relevant permitting organization to assign the LUP request to;
generating, via the analytical manager, an LUP report associated with constructing a permit structure, wherein the permit structure is based on geometry information of the retrieved spatial data, and the permit structure defines one or more permit types, the target site of a land location, and a period of use of one or more target land use permits, and at least one organization responsible for reviewing the LUP report;
sending, via a network, the LUP report to the at least one organization responsible for reviewing the report; and
outputting the LUP report to a user.

15. The method of claim 14 further comprising assigning the one or more target land use permits to a user associated with at least one organization.

16. The system of claim 10 wherein the spatial data includes layer information, geometry information, and element information.

17. The system of claim 6 wherein the electronic command may further cause the analytic manager to construct a permit structure based on geometric information of spatial data for the one or more target land use permits.

18. The system of claim 17 wherein the permit structure defines a permit type, a target location, and a period of use for each of the one or more target land use permits.

19. The system of claim 14 further including generating, via the analytical manager, a report including a list of relevant organizations associated with the retrieved spatial data and assigning the generated report to the relevant organizations provided in the list.
